(19) United States
(12) Patent Application Publication
(10) Pub. No.: US 2026/0153667 A1
(43) Pub. Date: Jun. 4, 2026

(54) BACKLIGHT MODULE AND DISPLAY DEVICE

(71) Applicant: Guangzhou China Star Optoelectronics Semiconductor Display Technology Co., LTd., Guangzhou, Guangdong (CN)

(72) Inventor: Hui LEI, Guangzhou, Guangdong (CN)

(73) Assignee: Guangzhou China Star Optoelectronics Semiconductor Display Technology Co., LTd., Guangzhou, Guangdong (CN)

(21) Appl. No.: 18/697,473

(22) PCT Filed: Mar. 7, 2024
(86) PCT No.: PCT/CN2024/080486

§ 371 Date: Mar. 31, 2024

(30) Foreign Application Priority Data
Feb. 4, 2024 (CN) 202410160527.4

(51) Int. Cl. F21V 8/00

(52) U.S. Cl. CPC G02B 6/0091

(57) ABSTRACT

An embodiment of the present application discloses a backlight module and a display device disposing a support member between a flexible circuit board and a backplate. Also, an elastic modulus of the support member is greater than an elastic modulus of the flexible circuit board.

### FIELD OF INVENTION

The present application relates to a field of display technologies, especially to a backlight module and a display device.

### BACKGROUND OF INVENTION

In display devices related technology, it includes a backlight module and a liquid crystal display panel. The backlight module comprises a back frame, a light guide plate, and a light bar set within the back frame. The light bar is positioned on one side of the light guide plate, and a flexible circuit board is connected to the light bar and positioned on one side of the light guide plate near the back frame's bottom plate. The flexible circuit board and the light guide plate are connected via adhesive, adopting the method of fixing the light guide as a whole to reduce the gap between the light guide plate and the light bar after aging, thereby reducing light loss.

In the research and practical process of the related technology, the inventors of the present application found that in aging experiments (such as TST), the flexible circuit board expands and contracts with the light guide plate, causing local bulging, which lifts the local part of the light guide plate and thus affects the light emission rate.

### SUMMARY OF INVENTION

An embodiment of the present application provides a backlight module and a display device that can reduce a risk of local bulging of the flexible circuit board.

The embodiment of the present application provides a backlight module, module, comprising:
a backplate;
a light emitting assembly, wherein the light emitting assembly is disposed on the backplate, and the light emitting assembly comprises a flexible circuit board and a light emitting device connected to and disposed on a side of the flexible circuit board away from the backplate;
a light guide plate, wherein a portion of the light guide plate is disposed on a side of the flexible circuit board away from the backplate and is connected securely to the flexible circuit board, and the light emitting device is disposed on a side of the light guide plate; and
a support member, wherein the support member is disposed between the flexible circuit board and the backplate, an elastic modulus of the support member is greater than an elastic modulus of the flexible circuit board.

Accordingly, the embodiment of the present application further provides a display device, comprising:
a backlight module; and
a liquid crystal display panel, wherein the liquid crystal display panel is disposed on a light exiting side of the backlight module;
wherein the backlight module comprises:
   a backplate;
   a light emitting assembly, wherein the light emitting assembly is disposed on the backplate, and the light emitting assembly comprises a flexible circuit board and a light emitting device connected to and disposed on a side of the flexible circuit board away from the backplate;
   a light guide plate, wherein a portion of the light guide plate is disposed on a side of the flexible circuit board away from the backplate and is connected securely to the flexible circuit board, and the light emitting device is disposed on a side of the light guide plate; and
   a support member, wherein the support member is disposed between the flexible circuit board and the backplate, an elastic modulus of the support member is greater than an elastic modulus of the flexible circuit board.

### DESCRIPTION OF DRAWINGS

FIG. 1 is a schematic structural bottom view of a backlight module of the embodiment of the present application;

FIG. 2 is a schematic structural view of a cross-section along line QQ in FIG. 1;

FIG. 3 is a schematic structural view of a cross-section along line MM in FIG. 1;

FIG. 4 is a schematic structural bottom view of a display device provided by the embodiment of the present application;

FIG. 5 is a cross-section schematic structural view along line RR in FIG. 4; and

FIG. 6 is a cross-section schematic structural view along line NN in FIG. 4.

### DETAILED DESCRIPTION OF PREFERRED EMBODIMENTS

The technical solution in the embodiment of the present application will be clearly and completely described below with reference to the accompanying drawings in the embodiments of the present application. Apparently, the described embodiments are merely some embodiments of the present application instead of all embodiments. According to the embodiments in the present application, all other embodiments obtained by those skilled in the art without making any creative effort shall fall within the protection scope of the present application. In addition, it should be understood that the specific embodiments described here are only used to illustrate and explain the present application, and are not used to limit the present application. In the present application, the used orientation terminologies such as “upper” and “lower”, when not specified to the contrary explanation, usually refer to the upper and lower states of the device in actual use or working conditions, specifically according to the direction of the figures in the drawings. Furthermore, “inner” and “outer” refer to the outline of the device. The terms “first,” “second,” “third,” etc., are used only for marking purposes and do not imply any numerical requirement or establish order.

The embodiment of the present application provides a backlight module and a display device, which will be described as follows. It should be explained that a describing order of the following embodiments is not a limit to a priority of the embodiments.

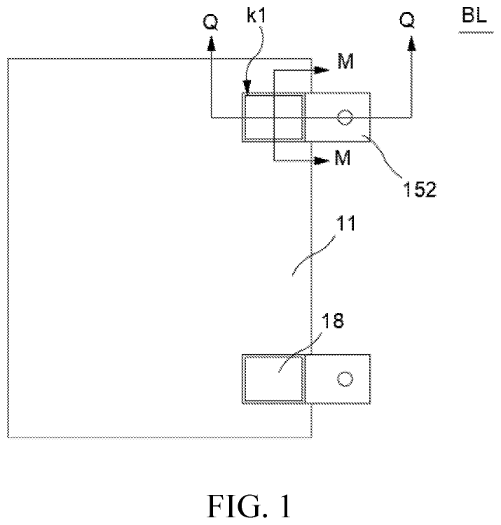

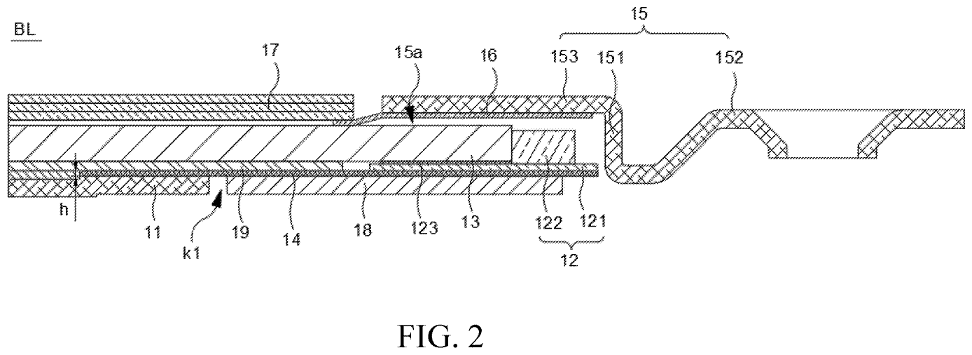

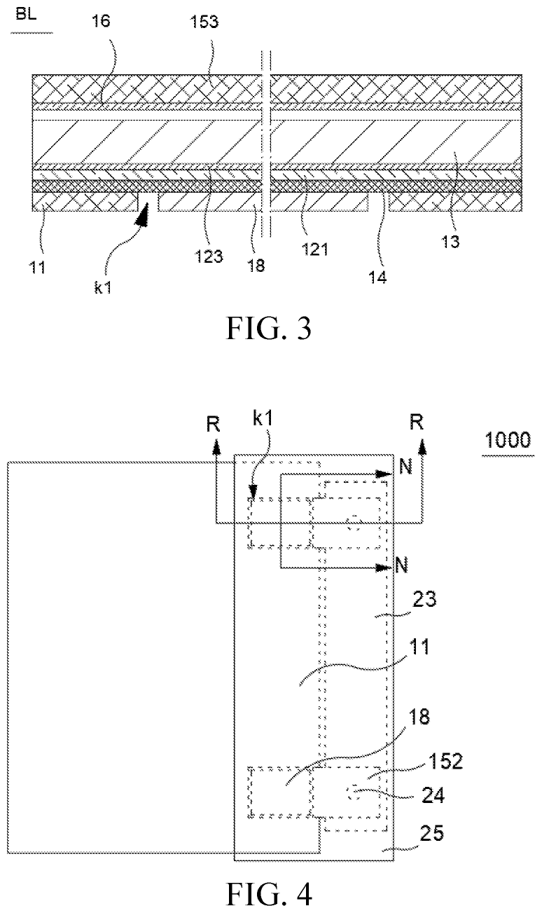

With reference to FIGS. 1 to 3, the embodiment of the present application provides a backlight module BL comprising a backplate 11, a light emitting assembly 12, a light guide plate 13, and a support member 14.

The light emitting assembly 12 is disposed on the backplate 11. The light emitting assembly 12 comprises a flexible circuit board 121 and a light emitting device 122 connected to and disposed on a side of the flexible circuit board 121 away from the backplate 11.

A portion of the light guide plate 13 is disposed on a side of the flexible circuit board 121 away from the backplate 11 and is connected securely to the flexible circuit board 121. The light emitting device 122 is disposed on a side of the light guide plate 13.

The support member 14 is disposed between the flexible circuit board 121 and the backplate 11. An elastic modulus of the support member 14 is greater than an elastic modulus of the flexible circuit board 121.

The backlight module BL of the embodiment of the present application disposes the support member 14 between the flexible circuit board 121 and the backplate 11, and the elastic modulus of the support member 1 is greater than the elastic modulus of flexible circuit board 121, and a greater rigidity of the support member 14 is used to support the flexible circuit board 121 or enhance a stiffness of the flexible circuit board 121, thereby lowering a risk of local bulging of the flexible circuit board 121 due to expansion or contraction of the light guide plate.

In some embodiments of the present application, the backlight module further comprises a frame, the frame comprises a frame body and a tab portion, the frame body is connected to a periphery of the backplate, and the tab portion is connected to a side of the frame body away from the light guide plate;
an aperture is defined in a side of the backplate near the tab portion, a side of the aperture near the tab portion penetrates the frame body, a width of the aperture is greater than or equal to a width of the tab portion; and
In an orthographic projection pattern of the backlight module, the support member at least covers a region of the flexible circuit board corresponding to the aperture.

In some embodiments of the present application, a surface of the support member near the flexible circuit board is connected securely to the flexible circuit board, and a surface of the support member away from the flexible circuit board is joined to the backplate.

In some embodiments of the present application, a surface of the support member near the flexible circuit board is joined to the flexible circuit board, and a surface of the support member away from the flexible circuit board is connected securely to the backplate.

In some embodiments of the present application, the backlight module further comprises a filler, and the filler is disposed in the aperture.

In some embodiments of the present application, the support member is at least joined to an opposite side of the same aperture.

In some embodiments of the present application, the support member further extends and is connected to a portion of the backplate corresponding to a side of the aperture away from the tab portion.

In some embodiments of the present application, the backlight module further comprises reflection plate, the reflection plate is disposed on a side of the light guide plate near the backplate, and the reflection plate extends and covers a portion of the support member; and
the flexible circuit board by adhesive layer is connected securely to the light guide plate, and a thickness of the reflection plate is equal to a sum of thicknesses of the adhesive layer and the flexible circuit board.

In some embodiments of the present application, the backplate is disposed on an entire surface of a corresponding region of the flexible circuit board, a surface of the support member near the flexible circuit board is connected securely to the flexible circuit board, and a surface of the support member away from the flexible circuit board is joined to the backplate.

In some embodiments of the present application, the support member is disposed on an entire surface, in an orthographic projection pattern of the backlight module, the support member completely covers the flexible circuit board.

In some embodiments of the present application, an elastic modulus of the support member is greater than or equal to 50 GPa.

In some embodiments of the present application, a thermal conductivity of the support member is greater than or equal to 10 W/(m·K).

In some embodiments of the present application, a thickness of the support member ranges from 0.1 millimeters to 0.3 millimeters.

In some embodiments of the present application, material of the support member is a curing adhesive, and the support member is directly formed on a surface of the flexible circuit board away from the light guide plate.

Optionally, material of the backplate 11 comprises metal or other material. Furthermore, the material of the backplate 11 comprises metal.

The light emitting device 122 comprises a light emitting diode or other light source. The light emitting device 122 is disposed on a side of a light incident surface of the light guide plate 13.

In an embodiment of the present application, the backlight module BL further comprises a frame 15, the frame 15 comprises a frame body 151 and a tab portion 152. The frame body 151 is connected to a periphery of the backplate 11. The tab portion 152 is connected to a side of the frame body 151 away from the light guide plate 13.

An aperture k1 is defined in a side of the backplate 11 near the tab portion 152, and a side of the aperture k1 near the tab portion 152 penetrates the frame body 151. A width of the aperture k1 is greater than or equal to a width of the tab portion 152.

It should be understood that before assembling, the aperture k1 is configured to accommodate the tab portion 152. During assembling, the tab portion 152 is bent from the aperture k1 to a side of the frame body 151 away from the light guide plate 13 to facilitate fastening and connection of the tab portion 152 with a circuit board of the display panel. Before assembling, the tab portion 152 is disposed in the aperture k1 to facilitate accommodation of the tab portion 152, saving a design space of the tab portion 152, and protection of the tab portion 152.

Optionally, the frame 15 and the backplate 11 are formed in an one-piece structure to enhance a connection stability therebetween and save an assembling time thereof. Of course, the frame 15 and the backplate 11 can also be disposed separately, and be connected together by a physical method.

In an embodiment, the frame body 151 and the backplate 11 are disposed around to form a receiving recess 15a, the light emitting assembly 12, and the light guide plate 13 is disposed in the receiving recess 15a.
the frame 15 further comprises a junction portion 153, and the junction portion 153 is connected to a side of the frame body 151 away from the backplate 11 and extends above an edge of the receiving recess 15a. The junction portion 153 is configured to support the liquid crystal display panel.

In an embodiment, the backlight module BL can further comprise a light shielding adhesive 16. The light shielding adhesive 16 is adhered to the junction portion 153 near a side of the light guide plate 13 surface. A portion of the light shielding adhesive 16 extends and is disposed on the light guide plate 13.

The backlight module BL can further comprise an optical film 17, and the optical film 17 is disposed on a side of the light guide plate 13 away from the backplate 11. A portion of an edge of the optical film 17 is joined to the light shielding adhesive 16.

In an embodiment of the present application, the elastic modulus of the support member 14 is greater than or equal to 50 GPa. For example, the elastic modulus of the support member 14 can be 50 Gpa, 60 Gpa, 70 Gpa, 80 Gpa, 90 Gpa, 100 Gpa, 110 Gpa, 120 Gpa, 130 Gpa, 140 Gpa, 150 Gpa, 160 Gpa, 170 Gpa, 180 Gpa, 190 Gpa, 200 Gpa, 210 Gpa, 220 Gpa, 230 Gpa, 240 Gpa, or 250 Gpa.

An elastic modulus of the support member 14 greater than or less than 50 Gpa is selected to ensure that the support member 14 has sufficient supporting ability and stiffness to resist a deformation force of the flexible circuit board 121.

In an embodiment of the present application, a thickness h of the support member 14 ranges from 0.1 millimeters to 0.3 millimeters.

It can be understood that when the thickness h of the support member 14 is excessively small, a supporting strength thereof to the flexible circuit board 121 is insufficient. When the thickness h is excessively large, assembling becomes difficult because the limited space. Therefore, in combination with demands to stiffness of the support member 14, the thickness h of the support member 14 ranging from 0.1 millimeters to 0.3 millimeters is selected to ensure the supporting strength of the support member 14 to the flexible circuit board 121 and lower assembling difficulty.

Optionally, a thickness of the support member 14 can be 0.1 millimeters, 0.15 millimeters, 0.2 millimeters, 0.25 millimeters, or 0.3 millimeters.

Optionally, the support member 14 has a better thermal conductive ability to transmit heat on the flexible circuit board 121 to the backplate 11 for heat dissipation to improve heat dissipation rates of the flexible circuit board 121 and the light guide plate 13 to further lower a thermal expansion degree of the light guide plate 13 such that a deformation ability of the flexible circuit board 121 is weakened, which further reduces a risk of local bulging of the flexible circuit board 121.

In an embodiment of the present application, a thermal conductivity of the support member 14 is greater than or equal to 10 W/(m·K). For example, thermal conductivity of the support member 14 is 10 W/(m·K), 20 W/(m·K), 30 W/(m·K), 40 W/(m·K), 50 W/(m·K), 60 W/(m·K), 70 W/(m·K), 80 W/(m·K), 90 W/(m·K), 100 W/(m·K), 110 W/(m·K), 120 W/(m·K), 130 W/(m·K), 140 W/(m·K), 150 W/(m·K), 160 W/(m·K), 170 W/(m·K), 180 W/(m·K), 190 W/(m·K), or 200 W/(m·K).

Optionally, material of the support member 14 is metal. The elastic modulus of the metal support member 14 ranges from 71 Gpa to 193 Gpa, for example, the elastic modulus can be 71 Gpa, 72 Gpa, 73 Gpa, 74 Gpa, 75 Gpa, 76 Gpa, 77 Gpa, 78 Gpa, 79 Gpa, 80 Gpa, 90 Gpa, 100 Gpa, 110 Gpa, 120 Gpa, 130 Gpa, 140 Gpa, 150 Gpa, 160 Gpa, 170 Gpa, 180 Gpa, 190 Gpa, 191 Gpa, 192 Gpa, or 193 Gpa.

Optionally, thermal conductivity of the metal support member 14 ranges from 16.3 W/(m·K) to 110 W/(m·K), for example, thermal conductivity can be 16.3 W/(m·K), 16.4 W/(m·K), 16.5 W/(m·K), 17 W/(m·K), 18 W/(m·K), 19 W/(m·K), 20 W/(m·K), 30 W/(m·K), 40 W/(m·K), 50 W/(m·K), 60 W/(m·K), 70 W/(m·K), 80 W/(m·K), 90 W/(m·K), 100 W/(m·K), or 110 W/(m·K).

It can be understood that the metal support member 14 not only has stronger rigidity and stiffness, but also has a stronger thermal conductive ability, which can better reduce the risk of local bulging of the flexible circuit board 121.

In an embodiment, material of the support member 14 can also be non-metallic rigid material of, for example, carbon fiber, glass steel, or ceramic.

In an embodiment of the present application, a surface of the support member 14 near the flexible circuit board 121 is connected securely to the flexible circuit board 121, a surface of the support member 14 away from the flexible circuit board 121 is joined to the backplate 11.

In an orthographic projection pattern of the backlight module BL, the support member 14 at least covers a region of the flexible circuit board 121 corresponding to the aperture k1. Namely, the support member 14 can be disposed partially and can be disposed on an entire surface.

Fastening the support member 14 on the flexible circuit board 121 improves the stiffness of the flexible circuit board 121 to reduce the risk of local bulging of the flexible circuit board 121 due to expansion or contraction of the light guide plate.

Optionally, in an embodiment of the present application, the backlight module BL further comprises a filler 18, and the filler 18 is disposed in the aperture k1.

Filling the filler 18 in the aperture k1 increases the supporting ability to the flexible circuit board 121 in region of the aperture k1 to reduce the risk of great difference of supporting strengths of the flexible circuit board 121, which further reduces the risk of local bulging of the flexible circuit board 121.

Optionally, the filler 18 can be an adhesive tape or a pad.

Optionally, the filler 18 and the support member 14 are formed in an one-piece structure to enhance a connection stability therebetween. Also, the filler 18 serves as a positioning block to match the aperture k1 to improve an assembling efficiency.

Optionally, a thickness of the filler 18 is equal to a depth of the aperture k1.

The support member 14 is disposed on the filler 18.

Optionally, in an embodiment of the present application, the support member 14 are disposed on an entire surface. In the orthographic projection pattern of the backlight module BL, the support member 14 completely covers the flexible circuit board 121. The support member 14 completely covering an entire surface of the flexible circuit board 121 can increase a total stiffness of the flexible circuit board 121 and/or a total supporting strength to the flexible circuit board 121.

Optionally, in the embodiment of the support member 14 fastened on the flexible circuit board 121, material of the support member 14 can also be glue. The glue, after curing, has stronger rigidity and stiffness, and for example, the glue can be hot melt glue or diamond glue.

For example, material of the support member 14 is a curing adhesive. The support member 14 is directly formed on a surface of the flexible circuit board 121 away from the light guide plate 13. The support member 14 being a curing adhesive makes the support member 14 directly formed on the flexible circuit board 121 to save an adhesive layer.

Optionally, in an embodiment of the present application, the backplate 11 is disposed on an entire surface of a corresponding region of the flexible circuit board 121. A surface of the support member 14 near the flexible circuit board 121 is connected securely to the flexible circuit board 121, and a surface of the support member 14 away from the flexible circuit board 121 is joined to the backplate 11.

Namely, compared to the above embodiment, no aperture k1 or recess is disposed in a region of the backplate 11 corresponding to the flexible circuit board 121 such that the filler 18 can also be saved. Optionally, the backplate 11 is disposed on an entire flat surface. Under such circumstance, the support member 14 covers and is fastened on an entire surface of the flexible circuit board 121.

In an embodiment of the present application, a surface of the support member 14 near the flexible circuit board 121 is joined to the flexible circuit board 121. A surface of the support member 14 away from the flexible circuit board 121 is connected securely to the backplate 11.

In an orthographic projection pattern of the backlight module BL, the support member 14 at least covers a region of the flexible circuit board 121 corresponding to the aperture k1.

Namely, compared to some embodiments, the support member 14 is disposed securely on the backplate 11 and at least covers the aperture k1 such that the flexible circuit board 121 is not exposed by the aperture k1. Namely, the support member 14 can be disposed partially and can be disposed on an entire surface.

It can be understood that the support member 14 is used to shield the aperture k1 such that supporting strengths of a portion of the flexible circuit board 121 corresponding to the aperture k1 region and a portion of the not corresponding to the aperture k1 region should be consistent as possible to further lower the risk of local bulging of the flexible circuit board 121 and avoid or lower the risk of light leakage.

In an embodiment, the elastic modulus of the support member 14 is greater than an elastic modulus of the backplate 11 to drastically compensate the supporting strength of the flexible circuit board 121 corresponding to the region of the aperture k1 to further lower the risk of bulging of the flexible circuit board 121 due to expansion or contraction of the light guide plate 13.

In the embodiment of the support member 14 disposed securely on the backplate 11, the support member 14 can be connected securely to the backplate 11 by a physical method such as soldering, adhesive bonding, or interference fitting.

Optionally, in an embodiment of the present application, the support member 14 at least is joined to an opposite side of the same aperture k1.

The support member 14 at least joined to the opposite side of the aperture k1, improves the stability of the support member 14 connected to the backplate 11.

In an embodiment of the present application, the support member 14 further extends and is connected to a portion of the backplate 11 corresponding to a side of the aperture k1 away from the tab portion 152. Namely, the support member 14 is joined to three sides of the aperture k1, thereby further improving the stability of the support member 14 connected to the backplate 11.

In an embodiment of the present application, the backlight module BL further comprises a reflection plate 19. The reflection plate 19 is disposed on a side of the light guide plate 13 near the backplate 11. The reflection plate 19 extends and covers a portion of the support member 14.

The flexible circuit board 121 by an adhesive layer 123 is connected securely to the light guide plate 13. A thickness of the reflection plate 19 is equal to a sum of thicknesses of the adhesive layer 123 and the flexible circuit board 121.

The reflection plate 19 is configured to reflect light radiated to the backplate 11 direction, thereby improving a light exiting rate of the backlight module BL.

Furthermore, the thickness of the reflection plate 19 is equal to a sum of the thicknesses of the adhesive layer 123 and the flexible circuit board 121 such that the light guide plate 13 can be disposed flat.

Optionally, the reflection plate 19 is connected securely to the backplate 11 by the adhesive layer.

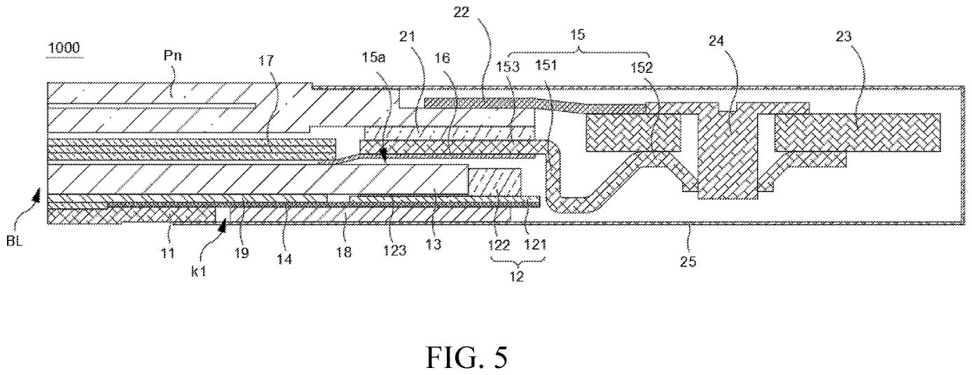

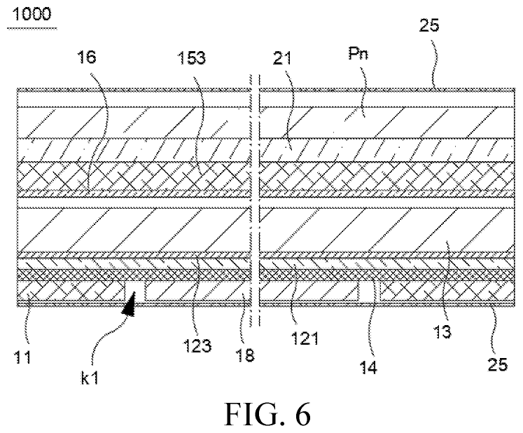

With reference to FIGS. 4 to 6, accordingly, the embodiment of the present application further provides a display device 1000, comprising: a liquid crystal display panel Pn and the backlight module BL of any one of the above embodiments.

The liquid crystal display panel Pn is disposed on a light exiting side of the backlight module BL.

Optionally, the liquid crystal display panel Pn is fastened on a side of the junction portion 153 away from the backlight module BL by a fastening adhesive 21.

It should be explained that the backlight module BL of the display device 1000 is similar to or the same as the structure of the backlight module BL of any one of the above embodiments, and therefore no repeated description is here.

Optionally, the display device 1000 can comprise a chip on film 22 and a printed circuit board 23. An end of the chip on film 22 is connected to the liquid crystal display panel Pn, and another end of the chip on film 22 is connected to the printed circuit board 23. The printed circuit board 23 by is fastened on the tab portion 152 by a threaded member 24.

Optionally, the display device 1000 further comprises a light shielding adhesive tape 25. The light shielding adhesive tape 25 covers the bonding region, the chip on film 22, the printed circuit board 23, the tab portion 152, and a side of the backplate 11 away from the light guide plate 13 of the liquid crystal display panel Pn.

The display device 1000 of the embodiment of the present application disposes the support member 14 between the flexible circuit board 121 and the backplate 11, and the elastic modulus of the support member 1 is greater than the elastic modulus of flexible circuit board 121, and a greater rigidity of the support member 14 is used to support the flexible circuit board 121 or enhance a stiffness of the flexible circuit board 121, thereby lowering a risk of local bulging of the flexible circuit board 121 due to expansion or contraction of the light guide plate.

The backlight module and the display device provided by the embodiment of the present application are described in detail as above. In the specification, the specific examples are used to explain the principle and embodiment of the present application. The above description of the embodiments is only used to help understand the method of the present application and its spiritual idea. Meanwhile, for those skilled in the art, according to the present idea of invention, changes will be made in specific embodiment and application. In summary, the contents of this specification should not be construed as limiting the present application.

1. A backlight module, comprising:
a backplate;
a light emitting assembly, wherein the light emitting assembly is disposed on the backplate, and the light emitting assembly comprises a flexible circuit board and a light emitting device connected to and disposed on a side of the flexible circuit board away from the backplate;
a light guide plate, wherein a portion of the light guide plate is disposed on a side of the flexible circuit board away from the backplate and is connected securely to the flexible circuit board, and the light emitting device is disposed on a side of the light guide plate; and
a support member, wherein the support member is disposed between the flexible circuit board and the backplate, an elastic modulus of the support member is greater than an elastic modulus of the flexible circuit board.

2. The backlight module according to claim 1, wherein the backlight module further comprises a frame, the frame comprises a frame body and a tab portion, the frame body is connected to a periphery of the backplate, and the tab portion is connected to a side of the frame body away from the light guide plate;
an aperture is defined in a side of the backplate near the tab portion, a side of the aperture near the tab portion penetrates the frame body, a width of the aperture is greater than or equal to a width of the tab portion; and
wherein in an orthographic projection pattern of the backlight module, the support member at least covers a region of the flexible circuit board corresponding to the aperture.

3. The backlight module according to claim 2, wherein a surface of the support member near the flexible circuit board is connected securely to the flexible circuit board, and a surface of the support member away from the flexible circuit board is joined to the backplate.

4. The backlight module according to claim 2, wherein a surface of the support member near the flexible circuit board is joined to the flexible circuit board, and a surface of the support member away from the flexible circuit board is connected securely to the backplate.

5. The backlight module according to claim 2, wherein the backlight module further comprises a filler, and the filler is disposed in the aperture.

6. The backlight module according to claim 5, wherein the support member is at least joined to an opposite side of the same aperture.

7. The backlight module according to claim 6, wherein the support member further extends and is connected to a portion of the backplate corresponding to a side of the aperture away from the tab portion.

8. The backlight module according to claim 7, wherein the backlight module further comprises reflection plate, the reflection plate is disposed on a side of the light guide plate near the backplate, and the reflection plate extends and covers a portion of the support member; and
the flexible circuit board by adhesive layer is connected securely to the light guide plate, and a thickness of the reflection plate is equal to a sum of thicknesses of the adhesive layer and the flexible circuit board.

9. The backlight module according to claim 1, wherein the backplate is disposed on an entire surface of a corresponding region of the flexible circuit board, a surface of the support member near the flexible circuit board is connected securely to the flexible circuit board, and a surface of the support member away from the flexible circuit board is joined to the backplate.

10. The backlight module according to claim 9, wherein the support member is disposed on an entire surface, in an orthographic projection pattern of the backlight module, the support member completely covers the flexible circuit board.

11. The backlight module according to claim 9, wherein material of the support member is a curing adhesive, and the support member is directly formed on a surface of the flexible circuit board away from the light guide plate.

12. The backlight module according to claim 1, wherein an elastic modulus of the support member is greater than or equal to 50 GPa.

13. The backlight module according to claim 1, wherein a thermal conductivity of the support member is greater than or equal to 10 W/(m·K).

14. A display device, comprising:
a backlight module; and
a liquid crystal display panel, wherein the liquid crystal display panel is disposed on a light exiting side of the backlight module;
wherein the backlight module comprises:
a backplate;
a light emitting assembly, wherein the light emitting assembly is disposed on the backplate, and the light emitting assembly comprises a flexible circuit board and a light emitting device connected to and disposed on a side of the flexible circuit board away from the backplate;
a light guide plate, wherein a portion of the light guide plate is disposed on a side of the flexible circuit board away from the backplate and is connected securely to the flexible circuit board, and the light emitting device is disposed on a side of the light guide plate; and
a support member, wherein the support member is disposed between the flexible circuit board and the backplate, an elastic modulus of the support member is greater than an elastic modulus of the flexible circuit board.

15. The display device according to claim 14, wherein the backlight module further comprises a frame, the frame comprises a frame body and a tab portion, the frame body is connected to a periphery of the backplate, and the tab portion is connected to a side of the frame body away from the light guide plate;
an aperture is defined in a side of the backplate near the tab portion, a side of the aperture near the tab portion penetrates the frame body, a width of the aperture is greater than or equal to a width of the tab portion; and
wherein in an orthographic projection pattern of the backlight module, the support member at least covers a region of the flexible circuit board corresponding to the aperture.

16. The display device according to claim 15, wherein a surface of the support member near the flexible circuit board is connected securely to the flexible circuit board, and a surface of the support member away from the flexible circuit board is joined to the backplate.

17. The display device according to claim 15, wherein a surface of the support member near the flexible circuit board is joined to the flexible circuit board, and a surface of the support member away from the flexible circuit board is connected securely to the backplate.

18. The display device according to claim 15, wherein the backlight module further comprises a filler, and the filler is disposed in the aperture.

19. The display device according to claim 18, wherein the support member at least is joined to an opposite side of the same aperture.

20. The display device according to claim 19, wherein the support member further extends and is connected to a portion of the backplate corresponding to a side of the aperture away from the tab portion.
